(19) United States
(12) Patent Application Publication
(10) Pub. No.: US 2009/0047949 A1
(43) Pub. Date: Feb. 19, 2009

(54) METHOD, SYSTEM AND MSC FOR LOAD REALLOCATION UNDER A-FLEX ARCHITECTURE

(75) Inventors: Yan LI, Shenzhen (CN); Fang YOU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/237,609

(22) Filed: Sep. 25, 2008

Related U.S. Application Data
(63) Continuation of application No. PCT/CN2007/000934, filed on Mar. 22, 2007.

(30) Foreign Application Priority Data
Mar. 27, 2006 (CN) 200610060057.6

(51) Int. Cl. H04W 4/00

(52) U.S. Cl. 455/433

(57) ABSTRACT

A load reallocation method operable under A-FLEX architecture includes: determining from configuration information, by an MSC, whether an MS needs to move out of the controlled range of the MSC; and transmitting, by the MSC, a registration request message to a BSC when determining that the MS needs to move out of the controlled range of the MSC, the BSC configured to instruct the MS to initiate a new registration so as to register with a new MSC. In cases where the loading balance changes when a service is ongoing, after the MSC completes the service, the MS is required to initiate a new location registration to a new MSC so that the loading of the present MSC may be reduced as soon as possible and the loading across the MSCs may be rebalanced after connection is established. The disclosure also provides a load reallocation system and an MSC operable under the A-FLEX architecture.

### CROSS-REFERENCE TO RELATED APPLICATIONS

This application is a continuation of International Patent Application No. PCT/CN2007/000934, filed Mar. 22, 2007, which claims priority to Chinese Patent Application No. 200610060057.6, filed Mar. 27, 2006, both of which are hereby incorporated by reference in their entirety.

### FIELD OF THE INVENTION

The invention relates to the technical field of A-FLEX, and more particularly, to a method, system and mobile switching center (MSC) for load reallocation operable under A-FLEX architecture.

### BACKGROUND

With fast development of telecommunication systems, security has become an increasingly important concern to telecommunication operators. In a telecommunication system, a large amount of out-of-service caused due to single-point failure has an especially serious impact on the security of the system. Accordingly, how to prevent a large amount of out-of-service caused due to single-point failure becomes a problem that has to be overcome.

Iu interface Flexibility (Iu-Flex) is one of the currently known disaster-tolerant mechanisms for the circuit domain under the soft switch architecture. Iu-Flex is proposed in Release 5 of the third Generation Partnership Project (3GPP), in which the concept “pool” is defined to include a plurality of radio network controllers (RNC)/base station controllers (BSC) and a plurality of core network (CN) elements. Each RNC/BSC node may be coupled to several CN elements. Generally, the Iu-Flex mechanism may ensure by means of the network resource identifier (NRI) that when a subscriber roams across different regions managed by the RNCs in a pool, all CN processes are performed on a particular CN node in the pool. That is, for a single subscriber, there is only one “home” CN processing node in the pool, and there is no concept of CN load sharing. In this way, frequent location updates may be avoided. All the subscribers in a pool are divided into different “home” CN nodes, and thus the load is shared. Such a division of a subscriber into a “home” CN node in the pool shall be determined by the RNC when the subscriber registers with the pool for the first time. The determination is to perform allocation with the IMSI-HASH (International Mobile Subscriber Identity-HASH) algorithm. A subscriber registers with a particular CN node, which returns an NRI to the subscriber after the registration is completed, the NRI including information about the CN node. The subscriber may carry NRI in any subsequent NAS (Non Access Stratum) message in the pool. The RNC returns the messages to the “home” CN according to the NRI. In cases where a CN node fails in the pool, the RNC adjusts the subscriber home to the CN node to another CN node.

As shown in FIG. 1, a mechanism similar to Iu-Flex may be deployed in the CDMA2000 radio core network, and is referred to as A interface Flexibility (A-Flex). Under this architecture, a BSC is shared by all mobile switching centers (MSC) in the pool. When a subscriber roams into the controlled range of a BSC (for example, BSC0) in the pool, the BSC selects an MSC based on the IMSI in the registration message and the current loading condition of the MSCs in the pool, and registers the subscriber with the MSC. When a service is later rendered to the subscriber, the BSC transfers a message sent from the subscriber to the associated MSC based on the IMSI carried in the message and the current loading condition of the MSCs in the pool. Typically, the loading condition of the MSCs in the pool keeps unchanged, and thus the message is sent to the MSC with which the subscriber is registered.

Under such an architecture, when load reallocation is needed for an MSC due to overloading or maintenance, the MS can only send a connection establishment message carrying IMSI (the connection establishment message includes location registration request, initial service request, and the callee paging response) or a non-connection establishment message carrying IMSI so that the BSC sends these messages to a new MSC according to the IMSI and the subscriber registers with the new MSC. However, no IMSI is carried in subsequent messages after connection establishment. The IMSI is needed for the BSC to select an MSC. If no IMSI is carried in a message, the MSC can only be selected based on the established connection. If the connection is already established or the above messages are not involved during service establishment, the MS will not send the above messages either. Accordingly, load reallocation cannot be implemented. When the subscriber is called next time, the service is still rendered at the original MSC, and the purpose of fast load allocation cannot be realized.

Therefore, load reallocation across the MSCs after connect establishment cannot be addressed in the prior art.

### SUMMARY

An object of the invention is to provide a method, system and mobile switching center (MSC) for load reallocation operable under A-FLEX architecture, so as to solve the problem that fast load reallocation cannot be performed because a subscriber cannot move from the current MSC to a new MSC when the load balance changes after connection establishment under the A-FLEX architecture.

To achieve the above object, the disclosure provides an embodiment of a load reallocation method operable under A-FLEX architecture, including:

a. determining from configuration information, by an MSC, whether a mobile station (MS) needs to move out of the controlled range of the MSC, and proceeding to step b when determining that the MS needs to move out of the controlled range of the MSC; and

b. transmitting, by the MSC, a registration request message to a base station controller (BSC) so that the BSC instructs the MS to initiate a new registration so as to register with a new MSC.

The disclosure also provides an embodiment of a load reallocation system operable under A-FLEX architecture, including a BSC, an MS registered with the BSC and a plurality of MSCs sharing the BSC. The MSC is configured to determine from configuration information whether the MS needs to move out of the controlled range of the MSC, and transmit a registration request message to the BSC when determining that the MS needs to move out of the controlled range of the MSC, and the BSC is configured to instruct the MS to initiate a new registration so as to register with a new MSC.

The disclosure also provides an embodiment of an MSC operable under A-FLEX architecture, including a load reallocation unit, configured to determine from configuration information whether an MS needs to move out of the controlled range of the MSC, and transmit a request message to the BSC instructing the MS to register with a new MSC when determining that the MS needs to move out of the controlled range of the MSC.

According to embodiments of the invention, the defects of the prior art may be overcome. In cases where the loading balance changes when a service is ongoing, once the original MSC completes the service, the original MSC requires the MS to initiate a new location registration to a new MSC. In this way, if an MSC is overloaded, the service is rendered at most once and then the subscriber is moved to a new MSC. Accordingly, the loading of the present MSC may be reduced as soon as possible and the loading across the MSCs may be rebalanced. This may avoid the limitation in the prior art that once the loading balance changes, a subscriber can move to a new MSC only when some particular services are ongoing. Accordingly, it may reduce the possibility that the loading condition of the original MSC further degrades due to the fact that subsequent services are still rendered at the original MSC.

### BRIEF DESCRIPTION OF THE DRAWINGS

FIG. 1 is a diagram illustrating the A-Flex architecture;

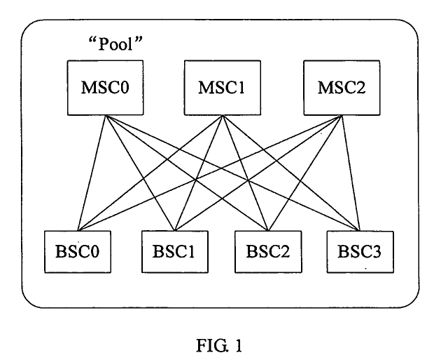

FIG. 2 is a diagram illustrating a first embodiment of the invention; and

FIG. 3 is a diagram illustrating a second embodiment of the invention.

### DETAILED DESCRIPTION

The principle of the embodiments of the invention may be summarized as: in cases where load reallocation is needed when a service is ongoing, the original MSC generates configuration information based on the current loading condition to be redistributed or an external instruction, the configuration information indicating subscribers that need to move out of the original MSC. To maintain service continuity, the original MSC continues to complete the current service. Once the service is completed, the MSC determines from the configuration information whether the MS needs to move out of the controlled range of the MSC. If the MS needs to move out of the controlled range of the MSC, a location registration request is sent to the current BSC so as to instruct the MS to initiate a new location registration. The BSC registers the MS with another MSC based on the IMSI of the MS and the loading condition of the MSCs.

An embodiment of the invention provides a load reallocation system operable under A-FLEX architecture, including a BSC, an MS registered with the BSC and a plurality of MSCs sharing the BSC, where the MSC is configured to determine from configuration information whether the MS needs to move out of the controlled range of the MSC, and to transmit a registration request message to the BSC when determining that the MS needs to move out of the controlled range of the MSC, and the BSC is configured to instruct the MS to initiate a new registration so as to register with a new MSC. In the system, the BSC transmits the registration request message to the MS over the air interface, the MS initiates a new location registration request to the BSC, the BSC selects a new MSC, and the new MSC accepts the registration from the MS. Furthermore, a subscriber's IMSI is carried in a location registration request initiated from the MS to the BSC, and the BSC selects the new MSC based on the IMSI and the current loading condition of the MSCs coupled with the BSC.

In an embodiment of the system, the MSC may include a load reallocation unit, configured to determine from configuration information whether an MS needs to move out of the controlled range of the MSC, and transmit a request message to the BSC instructing the MS to register with a new MSC when determining that the MS needs to move out of the controlled range of the MSC. In another embodiment of the system, the MSC may further include a configuration information generating unit, configured to determine whether load reallocation is needed, for example, determine whether load reallocation is needed before the service of an MS is ongoing or after an MS registers with the MSC, and to generate the configuration information from an external instruction or the current loading condition when load reallocation is needed. The generated configuration information may be stored in a storage unit of the system. Further detailed description is made below with reference to specific embodiments and the accompanying drawings.

### EMBODIMENT 1

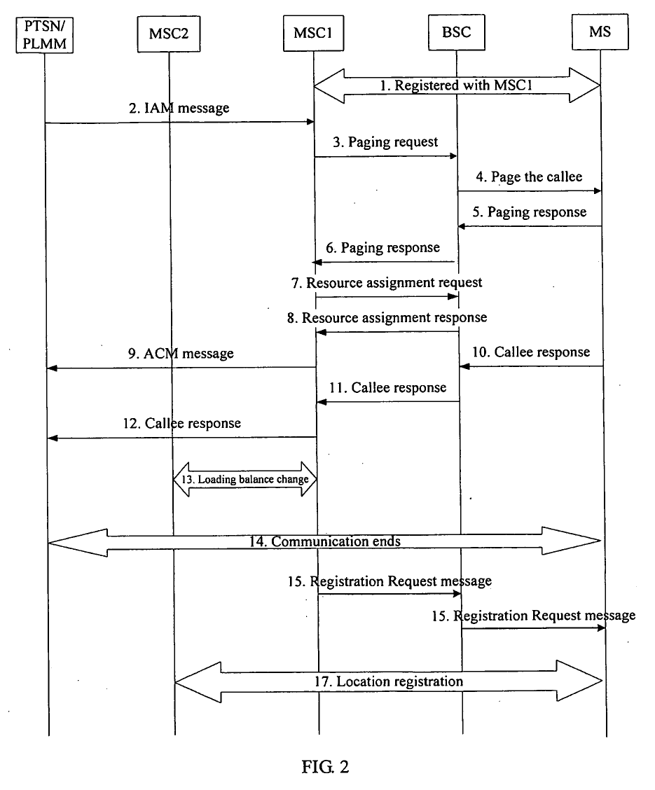

FIG. 2 shows the flow chart for processing a loading balance change when the service is ongoing. In FIG. 2, it is assumed that the MS registers with MSC1. The following steps are included.

1. The MS registers with MSC1.

2. The calling network sends an initial address message (IAM) to MSC1, the IAM message including the routing information about the callee.

3. Based on the routing information about the callee in the IAM message, MSC1 sends a paging request to the BSC where the subscriber is currently located.

4. The BSC pages the callee over the paging channel (by means of a Page Message).

5. The callee returns a paging response (by means of a Page Response Message).

6. The BSC returns the paging response to MSC1.

7. MSC1 sends a request for performing radio resource assignment to the BSC (by means of an Assignment Request message).

8. The BSC completes radio resource assignment and returns a resource assignment completion response (by means of an Assignment Response message).

9. MSC1 returns an Address Complete Message (ACM) to the calling side network.

10. The MS sends a callee response message to the current BSC (by means of a Connect Order message).

11. The BSC sends a callee response message to the MSC.

12. The MSC returns the response to the calling side network (by means of an ANM message).

13. If the loading balance changes during communication and reallocation is thus needed (for example, when the MSC needs maintenance and upgrade, a manual notification may be issued to the MSC to move subscribers, or alternatively, the software of the MSC founds an overload, and subscribers are moved automatically), the MSC generates configuration information from an external instruction (for example, operation & maintenance or O&M instruction) or the current changed loading condition. The configuration information may indicate which subscriber needs to move out of MSC1. For example, a format may be used as follows:

The subscriber IMSI of MSs
to move out of the MSC
460030907556XXX
460030907558XXX

In the above format, 460030907556XXX identifies that the subscriber IMSI identifiers falling within 460030907556000 to 460030907556999 need to move out of the MSC. The same holds true for 460030907558XXX.

14. The communication comes to an end.

15. If MSC1 determines from the configuration information generated at step 13 that the MS needs to move out of MSC1, a Registration Request message is sent to the BSC where the subscriber is currently located, the message including parameters such as the subscriber's IMSI identifier, and Cell Identifier List reported during subscriber registration. The MS is required to initiate a new location registration.

16. The BSC sends the message to the associated MS over the air interface based on the subscriber identifier and the cell identifier list.

17. Upon receipt of the registration request message, the MS completes location registration operation. The location registration operation includes the following specific steps.

1) The MS sends a registration message to the BSC where the subscriber is currently located, the message carrying the subscriber's IMSI.

2) The BSC receives the registration message, selects a new MSC (in the example, MSC2) based on the IMSI in the message and the current loading condition of the MSCs coupled with the BSC (the BSC will not select the original MSC1 because the loading balance has changed in step 13), and sends a location update message to the new MSC.

3) MSC2 returns a location update receipt message to the BSC.

4) The BSC returns the location update receipt message to the MS. Hereafter, the MS registers with the new MSC (that is, MSC2) and subsequent services are rendered at the new MSC.

It is to be noted that:

1. The messages such as IAM, ACM and ANM in the embodiment belong to the ISUP defined by the International Telecommunication Union—Telecommunication Standardization Sector (ITU-T). The formats may be referred to the ITU-T Q.763 protocol.

2. Although ITU-T ISUP is used as the inter-office call control signaling, alternative call control signaling is also possible, for example, ISUP defined by American National Standard Institute (ANSI), SIP-I defined by Internet engineering task force (IETF) and so on.

3. The message between the MSC and the BSC (for example, the registration request message Connect Order) may use the A interface protocol defined in 3GPP2, i.e. IOS protocol (Interoperability Specification for cdma2000 Access Network Interfaces), and the specific message format may be referred to the latest version of the protocol IOS 5.01.

### EMBODIMENT 2

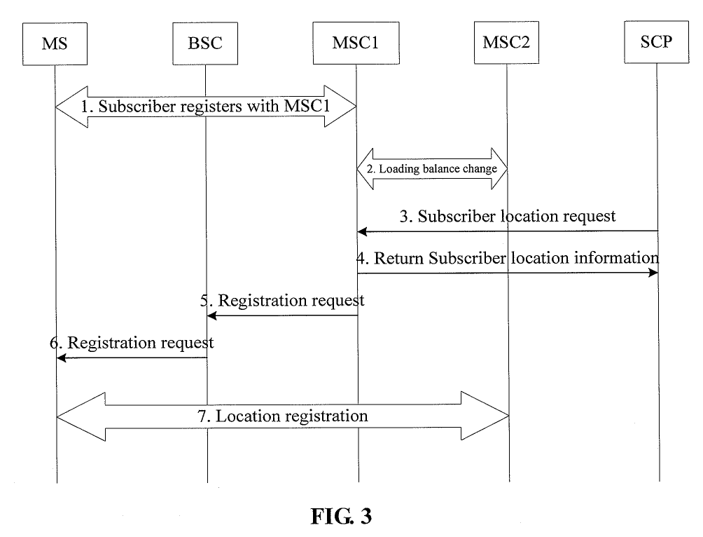

The flow for processing the loading balance change before a service is started is shown in FIG. 3, including the following steps.

1. The subscriber registers with MSC1.

2. If the loading balance changes and reallocation is needed, the MSC generates configuration information from an external instruction (for example, an O&M instruction) or the current changed loading condition. The configuration information indicates which subscribers need to move out of MSC1.

3. The SCP sends a subscriber location request message to MSC1.

4. MSC1 returns the location information about the subscriber.

5. If MSC1 determines from the configuration information generated at step 2 that the subscriber needs to move out of MSC1, a registration request message is sent to the BSC where the subscriber is currently located, to request the MS to initiate a new location registration.

6. The BSC sends the message to the associated MS over the air interface.

7. Upon receipt of the registration request message, the MS completes the location registration operation. The specific location registration operation includes:

1) The MS sends the registration message to the current BSC, the message carrying the subscriber's IMSI.

2) Upon receipt of the registration message, the BSC selects a new MSC (in the example, MSC2) based on the IMSI in the message and the current loading condition of the MSCs coupled with the BSC (the BSC will not select the original MSC1 because the loading balance has changed in step 13), and sends a location update message to the new MSC.

3) MSC2 returns a location update receipt message to the BSC.

4) The BSC returns a registration receipt message to the MS. Hereafter, the MS registers with the new MSC—(that is, MSC2) and subsequent services are rendered at the new MSC.

What is claimed is:

1. A method for load reallocation operable under A-FLEX architecture, comprising:
a. determining from configuration information, by a mobile switching center (MSC), whether a mobile station (MS) needs to move out of the controlled range of the MSC, and proceeding to step b when determining that the MS needs to move out of the controlled range of the MSC; and
b. transmitting, by the MSC, a registration request message to a base station controller (BSC) so that the BSC instructs the MS to initiate a new registration so as to register with a new MSC.

2. The method according to claim 1, wherein if load reallocation is needed before a service is ongoing, the MSC generates the configuration information from an external instruction or the current loading condition.

3. The method according to claim 1, wherein after a subscriber registers with the MSC, if load reallocation is needed when a service is ongoing, the MSC completes the service and generates the configuration information from an external instruction or the current loading condition.

4. The method according to claim 2, wherein the external instruction is an O&M instruction.

5. The method according to claim 1, wherein the configuration information comprises information about MS(s) that need to move out of the controlled range of the MSC.

6. The method according to claim 1, wherein the BSC transmits the registration request message to the MS over the air interface;
the MS initiates a new location registration request to the BSC, the BSC selects a new MSC, and the new MSC accepts the registration from the MS.

7. The method according to claim 6, wherein a subscriber's IMSI is carried in the location registration request initiated from the MS to the BSC; and the BSC selects the new MSC based on the IMSI and the current loading condition of the MSCs coupled with the BSC.

8. A system for load reallocation operable under A-FLEX architecture, comprising a base station controller (BSC), a mobile station (MS) registered with the BSC and a plurality of mobile switching centers (MSC) sharing the BSC, wherein
the MSC is configured to determine from configuration information whether the MS needs to move out of the controlled range of the MSC, and to transmit a registration request message to the BSC when determining that the MS needs to move out of the controlled range of the MSC; and
the BSC is configured to instruct the MS to initiate a new registration so as to register with a new MSC.

9. The system according to claim 8, wherein the BSC transmits the registration request message to the MS over the air interface;
the MS initiates a new location registration request to the BSC, the BSC selects a new MSC, and the new MSC accepts the registration from the MS.

10. The system according to claim 9, wherein a subscriber's IMSI is carried in the location registration request initiated from the MS to the BSC; and the BSC selects the new MSC based on the IMSI and the current loading condition of the MSCs coupled with the BSC.

11. A mobile switching centers (MSC) operable under A-FLEX architecture, comprising:
a load reallocation unit, configured to determine from configuration information whether a mobile station (MS) needs to move out of the controlled range of the MSC, and to transmit a request message to the BSC instructing the MS to register with a new MSC when determining that the MS needs to move out of the controlled range of the MSC.

12. The MSC according to claim 11, further comprising:
a configuration information generating unit, configured to determine whether load reallocation is needed, and to generate the configuration information from an external instruction or the current loading condition when load reallocation is needed.
